(19) United States
(12) Patent Application Publication
(10) Pub. No.: US 2024/0266100 A1
(43) Pub. Date: Aug. 8, 2024

(54) INDUCTOR COMPONENT

(71) Applicant: Murata Manufacturing Co., Ltd., Kyoto-fu (JP)

(72) Inventors: Kazuki INAGAKI, Nagaokakyo-shi (JP); Kenichi TANI, Nagaokakyo-shi (JP); Yuuichirou YOSHIDA, Nagaokakyo-shi (JP)

(73) Assignee: Murata Manufacturing Co., Ltd., Kyoto-fu (JP)

(21) Appl. No.: 18/430,171

(22) Filed: Feb. 1, 2024

(30) Foreign Application Priority Data
Feb. 2, 2023 (JP) 2023-014764

(51) Int. Cl. H01F 17/00; H01F 27/29

(52) U.S. Cl. CPC H01F 17/0013; H01F 17/0006; H01F 27/292; H01F 2017/004

(57) ABSTRACT

An inductor component includes an element body, a coil in the element body and helically wound along an axis, and first and second outer electrodes at the element body and electrically connected to the coil. The element body includes first and second end surfaces facing each other, first and second lateral surfaces facing each other, a bottom surface connected between the first and second end surfaces and between the first and second lateral surfaces, and a top surface facing the bottom surface. The first and second outer electrodes are provided to at least the bottom surface. The axis is parallel to the bottom surface and intersects the first and second lateral surfaces. The coil includes coil wiring layers laminated along the axis, and via wiring layers each connecting the coil wiring layers adjacent in a direction of the axis.

### CROSS-REFERENCE TO RELATED APPLICATION

This application claims benefit of priority to Japanese Patent Application No. 2023-014764, filed Feb. 2, 2023, the entire content of which is incorporated herein by reference.

### BACKGROUND

### Technical Field

The present disclosure relates to an inductor component.

### Background Art

Hitherto, there is an inductor component described in Japanese Unexamined Patent Application Publication No. 2000-286125. This inductor component includes an element body, a coil provided in the element body and helically wound along an axis, and a first outer electrode and a second outer electrode provided to the element body and electrically connected to the coil. The coil includes a plurality of coil wiring layers laminated along the axis, and a plurality of via wiring layers each connecting the coil wiring layers adjacent in an axial direction.

### SUMMARY

In recent years, the inductor component has been downsized. It is found that, when the inductor component as in the related art is mounted on a mounting board in such a situation, a great stress is applied to a connection part between the via wiring layer and the coil wiring layer due to a thermal stress or a bending stress from the mounting board side, thereby leading to a risk of disconnection between the via wiring layer and the coil wiring layer.

In view of this, the present disclosure provides an inductor component in which the disconnection between the via wiring layer and the coil wiring layer can be prevented.

An inductor component according to one aspect of the present disclosure includes an element body; a coil provided in the element body and helically wound along an axis; and a first outer electrode and a second outer electrode provided to the element body and electrically connected to the coil. The element body includes a first end surface and a second end surface facing each other, a first lateral surface and a second lateral surface facing each other, a bottom surface connected between the first end surface and the second end surface and between the first lateral surface and the second lateral surface, and a top surface facing the bottom surface. The first outer electrode and the second outer electrode are provided to at least the bottom surface. The axis is parallel to the bottom surface and intersects the first lateral surface and the second lateral surface. The coil includes a plurality of coil wiring layers laminated along the axis, and a plurality of via wiring layers each connecting the coil wiring layers adjacent in a direction of the axis. The plurality of via wiring layers extends along a helix direction of the coil when viewed in the direction of the axis, and the plurality of via wiring layers includes a bottom surface-side via wiring layer positioned on the bottom surface side with respect to a central line between the top surface and the bottom surface of the element body, and a top surface-side via wiring layer positioned on the top surface side with respect to the central line. A contact area between the bottom surface-side via wiring layer and the coil wiring layer is larger than a contact area between the top surface-side via wiring layer and the coil wiring layer.

Among the plurality of via wiring layers, the bottom surface-side via wiring layer positioned on the bottom surface side with respect to the central line of the element body is a via wiring layer in which a central point of a central line along an extending direction of the via wiring layer is present, when viewed in the direction of the axis, on the bottom surface side with respect to the central line of the element body that passes through the center of gravity of the element body and is parallel to the bottom surface and the top surface. Among the plurality of via wiring layers, the top surface-side via wiring layer positioned on the top surface side with respect to the central line of the element body is similarly a via wiring layer in which a central point of a central line along an extending direction of the via wiring layer is present, when viewed in the direction of the axis, on the top surface side with respect to the central line of the element body that passes through the center of gravity of the element body and is parallel to the bottom surface and the top surface.

In a case where a plurality of bottom surface-side via wiring layers is present, the contact area between the bottom surface-side via wiring layer and the coil wiring layer is an average of all the contact areas measured between the bottom surface-side via wiring layers and the coil wiring layers. In a case where a plurality of top surface-side via wiring layers is present, the contact area between the top surface-side via wiring layer and the coil wiring layer is similarly an average of all the contact areas measured between the top surface-side via wiring layers and the coil wiring layers.

In the aspect described above, the contact area between the bottom surface-side via wiring layer and the coil wiring layer is larger than the contact area between the top surface-side via wiring layer and the coil wiring layer. Therefore, when the inductor component is mounted on the mounting board so that the bottom surface side of the element body faces the mounting board, the connection strength between the bottom surface-side via wiring layer closer to the mounting board and the coil wiring layer can further be improved.

Thus, disconnection between the bottom surface-side via wiring layer and the coil wiring layer can be prevented even if a great stress is applied mainly to the connection part between the bottom surface-side via wiring layer and the coil wiring layer due to a thermal stress or a bending stress from the mounting board side at the time of mounting. Accordingly, the disconnection between the bottom surface-side via wiring layer and the coil wiring layer can be prevented even in the situation where the inductor component has been downsized in recent years.

With the inductor component according to the one aspect of the present disclosure, the disconnection between the via wiring layer and the coil wiring layer can be prevented.

### BRIEF DESCRIPTION OF THE DRAWINGS

FIG. 1 is a perspective view illustrating a first embodiment of an inductor component;

FIG. 2 is a see-through front view from a first lateral surface side of the inductor component;

FIG. 3A is an exploded plan view of the inductor component;

FIG. 3B is an exploded plan view of the inductor component;

FIG. 3C is an exploded plan view of the inductor component;

FIG. 4 is a see-through front view illustrating a second embodiment of the inductor component from the first lateral surface side of the inductor component;

FIG. 5A is an exploded plan view of the inductor component;

FIG. 5B is an exploded plan view of the inductor component;

FIG. 5C is an exploded plan view of the inductor component;

FIG. 6 is a see-through front view illustrating a third embodiment of the inductor component from the first lateral surface side of the inductor component;

FIG. 7A is an exploded plan view of the inductor component;

FIG. 7B is an exploded plan view of the inductor component; and

FIG. 7C is an exploded plan view of the inductor component.

### DETAILED DESCRIPTION

An inductor component according to one aspect of the present disclosure is described below in detail based on illustrated embodiments. The drawings may partially include schematic drawings that do not reflect actual dimensions and ratios.

### First Embodiment

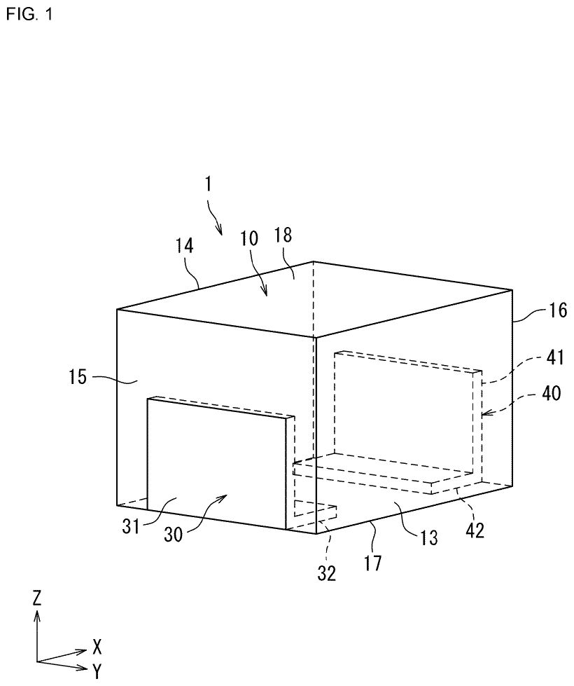

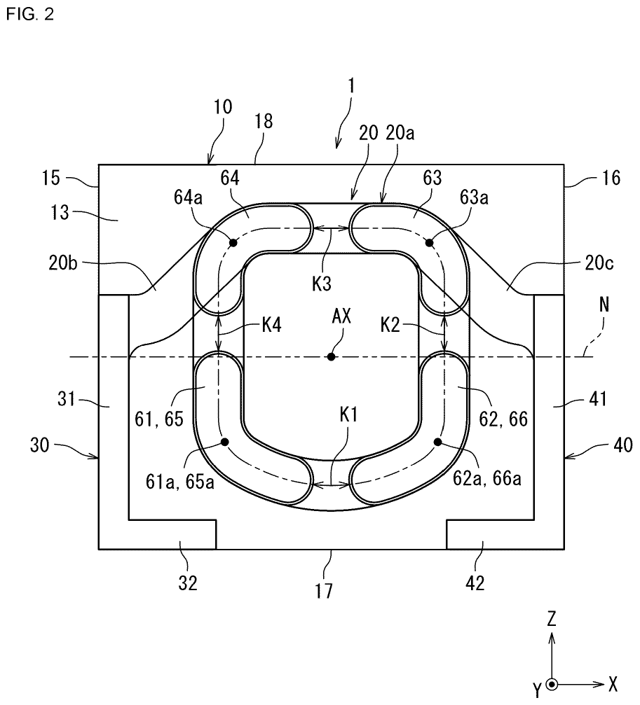

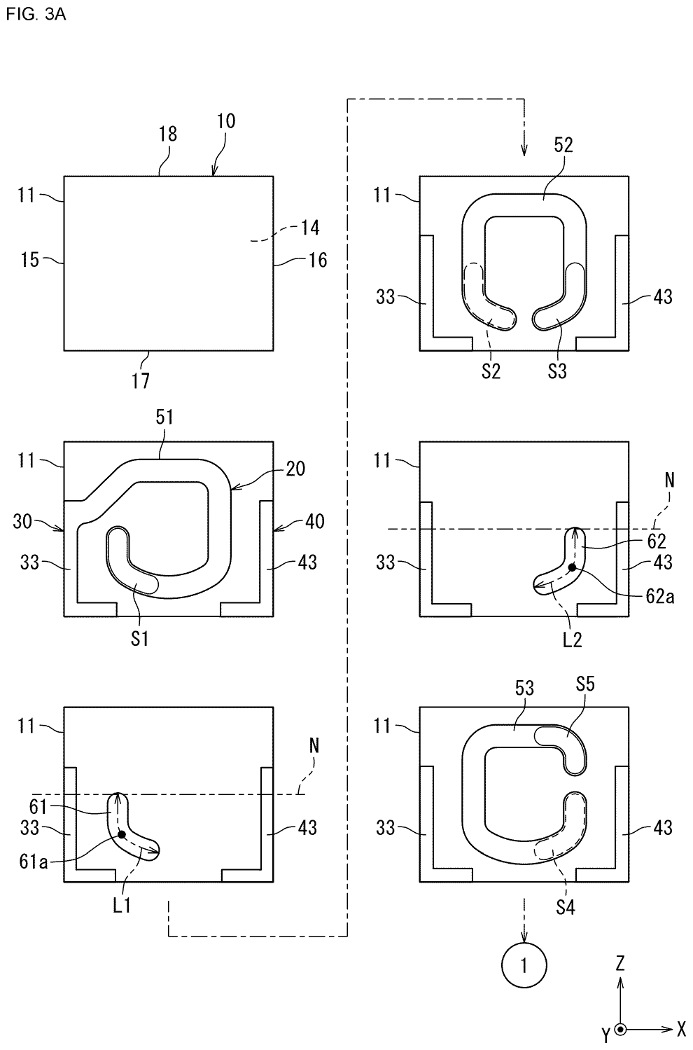

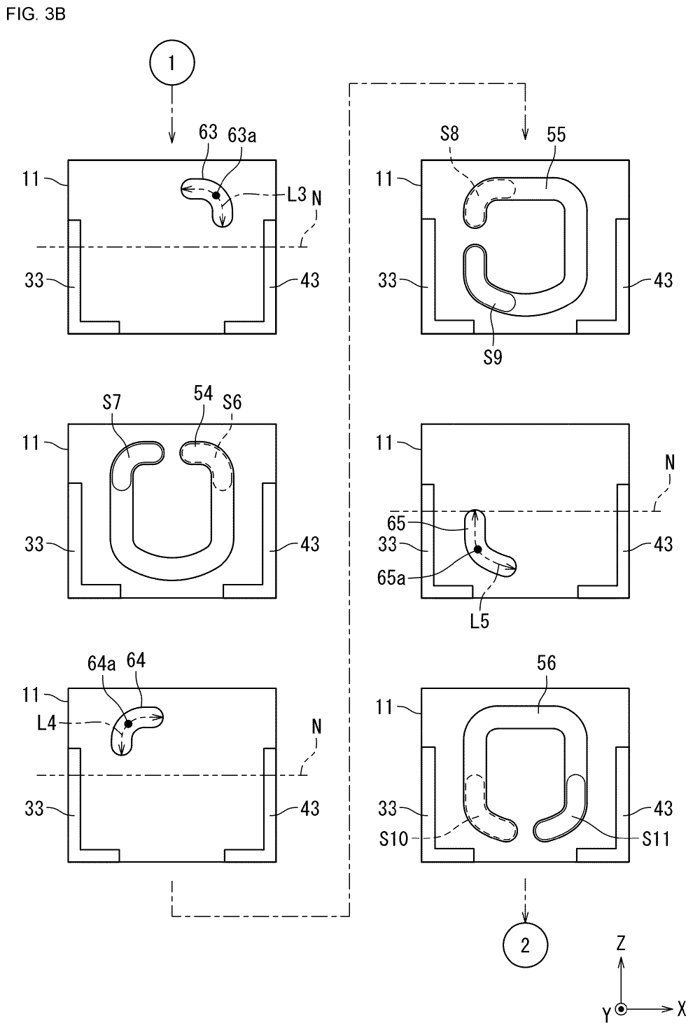

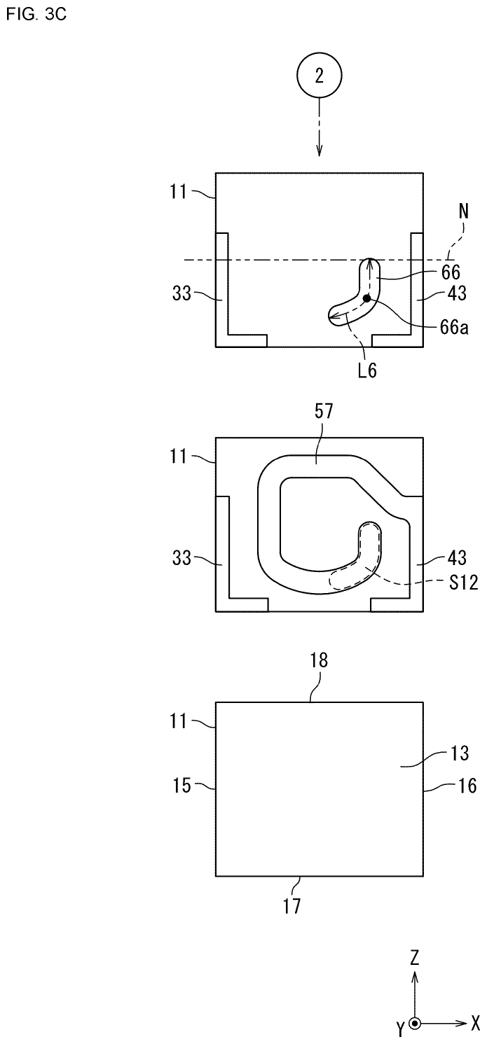

FIG. 1 is a perspective view illustrating a first embodiment of the inductor component. FIG. 2 is a see-through front view from a first lateral surface side of the inductor component. FIG. 3A, FIG. 3B, and FIG. 3C are exploded plan views of the inductor component. As illustrated in FIG. 1, FIG. 2, FIG. 3A, FIG. 3B, and FIG. 3C, an inductor component 1 includes an element body 10, a coil 20 provided in the element body 10 and helically wound along an axis AX, and a first outer electrode 30 and a second outer electrode 40 provided to the element body 10 and electrically connected to the coil 20. For convenience, the element body and the coil are depicted transparently in FIG. 2 to easily understand the structure, but may be semitransparent or opaque.

The inductor component 1 is electrically connected to wiring of a circuit board (not illustrated) via the first and second outer electrodes 30 and 40. For example, the inductor component 1 is used as a coil for impedance matching (matching coil) in a high-frequency circuit, and is used for electronic devices such as a personal computer, a DVD player, a digital camera, a TV, a mobile phone, car electronics, and medical or industrial machinery. The use of the inductor component 1 is not limited thereto. For example, the inductor component 1 may be used for a tuned circuit, a filter circuit, or a rectifying and smoothing circuit.

The element body 10 has a substantially rectangular parallelepiped shape. The surfaces of the element body 10 include a first end surface 15 and a second end surface 16 facing each other, a first lateral surface 13 and a second lateral surface 14 facing each other, a bottom surface 17 connected between the first end surface 15 and the second end surface 16 and between the first lateral surface 13 and the second lateral surface 14, and a top surface 18 facing the bottom surface 17. The bottom surface 17 is oriented toward a mounting board (not illustrated) when the inductor component 1 is mounted on the mounting board.

As in the illustration, an X direction is a direction from the first end surface 15 to the second end surface 16 and is orthogonal to the first end surface 15 and the second end surface 16. A Y direction is a direction from the second lateral surface 14 to the first lateral surface 13 and is orthogonal to the first lateral surface 13 and the second lateral surface 14. A Z direction is a direction from the bottom surface 17 to the top surface 18 and is orthogonal to the bottom surface 17 and the top surface 18. The X direction is also referred to as a length direction of the element body 10. The Y direction is also referred to as a width direction of the element body 10. The Z direction is also referred to as a height direction of the element body 10. The X direction, the Y direction, and the Z direction are orthogonal to each other, and constitute a left-handed system when X, Y, and Z are arranged in this order.

The element body 10 is formed by laminating a plurality of insulating layers 11. The insulating layer 11 is made of, for example, a material containing borosilicate glass as a main component, or a material such as ferrite or resin. The laminating direction of the insulating layers 11 is a direction parallel to the first and second end surfaces 15 and 16 and the bottom surface 17 of the element body 10 (Y direction). That is, the insulating layer 11 is a layer expanding on an XZ plane. The term “parallel” is not herein limited to a strict parallel relationship, and includes a substantially parallel relationship in consideration of an actual variation range. In the element body 10, the interfaces between the plurality of insulating layers 11 may be unclear due to baking or the like. In FIG. 3A, FIG. 3B, and FIG. 3C, an up-to-down direction is the laminating direction (Y direction).

The first outer electrode 30 and the second outer electrode 40 are made of conductive materials such as Ag, Cu, Au, or an alloy containing any of them as a main component. The first outer electrode 30 has an L-shape formed from the first end surface 15 to the bottom surface 17. The first outer electrode 30 is embedded in the element body 10 so as to be exposed from the first end surface 15 and the bottom surface 17. The first outer electrode 30 includes a first end surface portion 31 extending along the first end surface 15, and a first bottom surface portion 32 connected to the first end surface portion 31 and extending along the bottom surface 17.

The second outer electrode 40 has an L-shape formed from the second end surface 16 to the bottom surface 17. The second outer electrode 40 is embedded in the element body 10 so as to be exposed from the second end surface 16 and the bottom surface 17. The second outer electrode 40 includes a second end surface portion 41 extending along the second end surface 16, and a second bottom surface portion 42 connected to the second end surface portion 41 and extending along the bottom surface 17.

The first outer electrode 30 is structured such that a plurality of first outer electrode conductor layers 33 embedded in the element body 10 (insulating layers 11) is laminated. The second outer electrode 40 is structured such that a plurality of second outer electrode conductor layers 43 embedded in the element body 10 (insulating layers 11) is laminated. The first outer electrode conductor layer 33 extends along the first end surface 15 and the bottom surface 17. The second outer electrode conductor layer 43 extends along the second end surface 16 and the bottom surface 17.

Since the first and second outer electrodes 30 and 40 can be embedded in the element body 10 in this way, the inductor component can be downsized compared with a structure in which the outer electrodes are externally attached to the element body 10. Further, the coil 20 and the outer electrodes 30 and 40 can be formed in the same step, and variations in the positional relationships between the coil 20 and the outer electrodes 30 and 40 are reduced. Thus, variations in electric characteristics of the inductor component 1 can be reduced.

The first outer electrode 30 may have the first bottom surface portion 32 without the first end surface portion 31. Similarly, the second outer electrode 40 may have the second bottom surface portion 42 without the second end surface portion 41. That is, it is appropriate that the first outer electrode 30 and the second outer electrode 40 be provided to at least the bottom surface 17 of the element body 10.

The coil 20 is made of, for example, a conductive material similar to those of the first and second outer electrodes 30 and 40. The coil 20 is helically wound along the laminating direction of the insulating layers 11. The first end of the coil 20 is connected to the first outer electrode 30, and the second end of the coil 20 is connected to the second outer electrode 40. In this embodiment, the coil 20 and the first and second outer electrodes 30 and 40 are integrated and there is no clear boundary therebetween. However, there is no limitation, and the coil and the outer electrodes may have boundary therebetween by being made of different materials or by different methods.

The coil 20 is wound along the axis AX such that the axis AX is parallel to the bottom surface 17 and intersects the first lateral surface 13 and the second lateral surface 14. The axis AX of the coil 20 agrees with the laminating direction of the insulating layers 11 (Y direction). The axis AX of the coil 20 means a central axis of the helical shape of the coil 20.

The coil 20 includes a wound portion 20a, a first extended portion 20b connected between the first end of the wound portion 20a and the first outer electrode 30, and a second extended portion 20c connected between the second end of the wound portion 20a and the second outer electrode 40. In this embodiment, the wound portion 20a and the first and second extended portions 20b and 20c are integrated and there is no clear boundary therebetween. However, there is no limitation, and the wound portion and the extended portions may have boundary therebetween by being made of different materials or by different methods.

The wound portion 20a is helically wound along the axis AX. That is, the wound portion 20a refers to a helically wound portion where parts of the coil 20 overlap each other when viewed in a direction parallel to the axis AX. The first and second extended portions 20b and 20c refer to portions outside the overlapping portion.

When viewed in the direction of the axis AX of the coil 20, the coil 20 has a bilaterally symmetrical shape with respect to a straight line passing through the axis AX of the coil 20 and parallel to the Z direction. Thus, variations in the characteristics of the inductor component 1 can be suppressed.

As illustrated in FIG. 3A, FIG. 3B, and FIG. 3C, the coil 20 includes a plurality of coil wiring layers 51 to 57 laminated along the axis AX, and a plurality of via wiring layers 61 to 66 each positioned between and connecting the coil wiring layers adjacent in the direction of the axis AX. Each of the plurality of coil wiring layers 51 to 57 is provided to the insulating layer 11. Each of the plurality of via wiring layers 61 to 66 is provided to the insulating layer 11. When viewed in the direction of the axis AX, the plurality of coil wiring layers 51 to 57 and the plurality of via wiring layers 61 to 66 extend along the helix direction of the coil 20.

The plurality of coil wiring layers 51 to 57 constitutes the helix while being each wound along a plane and being electrically connected in series. Each of the plurality of coil wiring layers 51 to 57 is formed by being wound on a principal surface of the insulating layer 11 (XZ plane) orthogonal to the direction of the axis AX (Y direction). The number of turns of each of the coil wiring layers 51 to 57 is less than one, but may be one or more.

Each of the plurality of via wiring layers 61 to 66 extends through the insulating layer 11 in its thickness direction (Y direction). The coil wiring layers adjacent in the laminating direction are electrically connected in series via the via wiring layer. Thus, the plurality of coil wiring layers 51 to 57 constitutes the helix while being electrically connected in series.

Specifically, the first coil wiring layer 51, the second coil wiring layer 52, the third coil wiring layer 53, the fourth coil wiring layer 54, the fifth coil wiring layer 55, the sixth coil wiring layer 56, and the seventh coil wiring layer 57 are sequentially laminated along the Y direction. The end portion of the first coil wiring layer 51 is connected to the first outer electrode conductor layer 33 of the first outer electrode 30. The end portion of the seventh coil wiring layer 57 is connected to the second outer electrode conductor layer 43 of the second outer electrode 40.

The first via wiring layer 61 is positioned between the first coil wiring layer 51 and the second coil wiring layer 52, and connects the end portion of the first coil wiring layer 51 and the end portion of the second coil wiring layer 52. The second via wiring layer 62 is positioned between the second coil wiring layer 52 and the third coil wiring layer 53, and connects the end portion of the second coil wiring layer 52 and the end portion of the third coil wiring layer 53. The third via wiring layer 63 is positioned between the third coil wiring layer 53 and the fourth coil wiring layer 54, and connects the end portion of the third coil wiring layer 53 and the end portion of the fourth coil wiring layer 54.

The fourth via wiring layer 64 is positioned between the fourth coil wiring layer 54 and the fifth coil wiring layer 55, and connects the end portion of the fourth coil wiring layer 54 and the end portion of the fifth coil wiring layer 55. The fifth via wiring layer 65 is positioned between the fifth coil wiring layer 55 and the sixth coil wiring layer 56, and connects the end portion of the fifth coil wiring layer 55 and the end portion of the sixth coil wiring layer 56. The sixth via wiring layer 66 is positioned between the sixth coil wiring layer 56 and the seventh coil wiring layer 57, and connects the end portion of the sixth coil wiring layer 56 and the end portion of the seventh coil wiring layer 57.

As illustrated in FIG. 2, FIG. 3A, FIG. 3B, and FIG. 3C, when viewed in the direction of the axis AX, the plurality of via wiring layers 61 to 66 includes bottom surface-side via wiring layers positioned on the bottom surface 17 side with respect to a central line N between the top surface 18 and the bottom surface 17 of the element body 10, and top surface-side via wiring layers positioned on the top surface 18 side with respect to the central line N. The central line N is a straight line passing through the center of gravity of the element body 10 and parallel to the top surface 18 and the bottom surface 17. In FIG. 2, the central line N passes through the axis AX and overlaps the center of gravity of the element body 10, but the central line N or the center of gravity of the element body 10 may be separated from the axis AX. The center of gravity means a point at the center of the dimensions of the element body 10 in the length direction, the height direction, and the width direction, and the weights of members are ignored.

Among the plurality of via wiring layers 61 to 66, the bottom surface-side via wiring layer is a via wiring layer in which the central point in the extending direction of the via wiring layer is present on the bottom surface 17 side with respect to the central line N of the element body 10 when viewed in the direction of the axis AX. Specifically, the bottom surface-side via wiring layers are the first via wiring layer 61, the second via wiring layer 62, the fifth via wiring layer 65, and the sixth via wiring layer 66.

A central point 61a of a central line (indicated by a chain line) along the extending direction of the first via wiring layer 61 is present on the bottom surface 17 side with respect to the central line N. A central point 62a of a central line (indicated by a chain line) along the extending direction of the second via wiring layer 62 is present on the bottom surface 17 side with respect to the central line N. A central point 65a of a central line (indicated by a chain line) along the extending direction of the fifth via wiring layer 65 is present on the bottom surface 17 side with respect to the central line N. A central point 66a of a central line (indicated by a chain line) along the extending direction of the sixth via wiring layer 66 is present on the bottom surface 17 side with respect to the central line N.

Among the plurality of via wiring layers 61 to 66, the top surface-side via wiring layer is a via wiring layer in which the central point in the extending direction of the via wiring layer is present on the top surface 18 side with respect to the central line N of the element body 10 when viewed in the direction of the axis AX. Specifically, the top surface- side via wiring layers are the third via wiring layer 63 and the fourth via wiring layer 64.

A central point 63a of a central line (indicated by a chain line) along the extending direction of the third via wiring layer 63 is present on the top surface 18 side with respect to the central line N. A central point 64a of a central line (indicated by a chain line) along the extending direction of the fourth via wiring layer 64 is present on the top surface 18 side with respect to the central line N.

The contact area between the bottom surface-side via wiring layer and the coil wiring layer is larger than the contact area between the top surface-side via wiring layer and the coil wiring layer. Since the plurality of bottom surface-side via wiring layers is present including the first via wiring layer 61, the second via wiring layer 62, the fifth via wiring layer 65, and the sixth via wiring layer 66, the contact area between the bottom surface-side via wiring layer and the coil wiring layer is an average of all the contact areas measured between the bottom surface-side via wiring layers and the coil wiring layers. Since the plurality of top surface-side via wiring layers is similarly present including the third via wiring layer 63 and the fourth via wiring layer 64, the contact area between the top surface-side via wiring layer and the coil wiring layer is an average of all the contact areas measured between the top surface-side via wiring layers and the coil wiring layers.

Specifically, the first coil wiring layer 51 has a first contact surface S1 in contact with the first via wiring layer 61. The second coil wiring layer 52 has a second contact surface S2 in contact with the first via wiring layer 61, and a third contact surface S3 in contact with the second via wiring layer 62. The third coil wiring layer 53 has a fourth contact surface S4 in contact with the second via wiring layer 62, and a fifth contact surface S5 in contact with the third via wiring layer 63. The fourth coil wiring layer 54 has a sixth contact surface S6 in contact with the third via wiring layer 63, and a seventh contact surface S7 in contact with the fourth via wiring layer 64. The fifth coil wiring layer 55 has an eighth contact surface S8 in contact with the fourth via wiring layer 64, and a ninth contact surface S9 in contact with the fifth via wiring layer 65. The sixth coil wiring layer 56 has a tenth contact surface S10 in contact with the fifth via wiring layer 65, and an eleventh contact surface S11 in contact with the sixth via wiring layer 66. The seventh coil wiring layer 57 has a twelfth contact surface S12 in contact with the sixth via wiring layer 66.

The contact surfaces between the bottom surface-side via wiring layers and the coil wiring layers are the first contact surface S1, the second contact surface S2, the third contact surface S3, the fourth contact surface S4, the ninth contact surface S9, the tenth contact surface S10, the eleventh contact surface S11, and the twelfth contact surface S12. Thus, the contact area between the bottom surface-side via wiring layer and the coil wiring layer is an average of the area of the first contact surface S1, the area of the second contact surface S2, the area of the third contact surface S3, the area of the fourth contact surface S4, the area of the ninth contact surface S9, the area of the tenth contact surface S10, the area of the eleventh contact surface S11, and the area of the twelfth contact surface S12.

The contact surfaces between the top surface-side via wiring layers and the coil wiring layers are the fifth contact surface S5, the sixth contact surface S6, the seventh contact surface S7, and the eighth contact surface S8. Thus, the contact surface between the top surface-side via wiring layer and the coil wiring layer is an average of the area of the fifth contact surface S5, the area of the sixth contact surface S6, the area of the seventh contact surface S7, and the area of the eighth contact surface S8.

As a method for measuring the area of each contact surface, for example, the inductor component 1 is ground along the XZ plane and the area of each contact surface is measured. In a case where the entire via wiring layer is in contact with the coil wiring layer, the contact area may be the cross-sectional area of any cross section of the via wiring layer along the XZ plane.

In the structure described above, the contact area between the bottom surface-side via wiring layer and the coil wiring layer is larger than the contact area between the top surface-side via wiring layer and the coil wiring layer. Therefore, when the inductor component 1 is mounted on the mounting board so that the bottom surface 17 side of the element body 10 faces the mounting board, the connection strength between the bottom surface-side via wiring layer closer to the mounting board and the coil wiring layer can further be improved.

Thus, disconnection between the bottom surface-side via wiring layer and the coil wiring layer can be prevented even if a great stress is applied mainly to the connection part between the bottom surface-side via wiring layer and the coil wiring layer due to a thermal stress or a bending stress from the mounting board side at the time of mounting. Accordingly, the disconnection between the bottom surface-side via wiring layer and the coil wiring layer can be prevented even in the situation where the inductor component has been downsized in recent years.

The inventors of the present disclosure have found that the disconnection between the via wiring layer on the bottom surface side and the coil wiring layer is conspicuous because the stress applied to the side close to the mounting board, that is, the bottom surface side is greater than the stress applied to the side far from the mounting board, that is, the top surface side. Thus, the inventors of the present disclosure have conceived prevention of the disconnection between the bottom surface-side via wiring layer and the coil wiring layer such that the contact area between the bottom surface-side via wiring layer and the coil wiring layer is set larger than the contact area between the top surface-side via wiring layer and the coil wiring layer.

Since the via wiring layer extends along the helix direction of the coil 20, the contact area between the via wiring layer and the coil wiring layer can be secured and the reliability of connection can be improved. Since the via wiring layer extends along the helix direction of the coil, a via pad portion at the end portion of coil wiring can be omitted and a decrease in a Q factor due to provision of the via pad portion can be prevented.

It is preferred that the contact areas of all the bottom surface-side via wiring layers be larger than the contact areas of all the top surface-side via wiring layers. Specifically, the area of the first contact surface S1, the area of the second contact surface S2, the area of the third contact surface S3, the area of the fourth contact surface S4, the area of the ninth contact surface S9, the area of the tenth contact surface S10, the area of the eleventh contact surface S11, and the area of the twelfth contact surface S12 are larger than the area of the fifth contact surface S5, the area of the sixth contact surface S6, the area of the seventh contact surface S7, and the area of the eighth contact surface S8.

It is preferred that the total of the contact areas of the bottom surface-side via wiring layers be larger than the total of the contact areas of the top surface-side via wiring layers. Specifically, the total of the area of the first contact surface S1, the area of the second contact surface S2, the area of the third contact surface S3, the area of the fourth contact surface S4, the area of the ninth contact surface S9, the area of the tenth contact surface S10, the area of the eleventh contact surface S11, and the area of the twelfth contact surface S12 is larger than the total of the area of the fifth contact surface S5, the area of the sixth contact surface S6, the area of the seventh contact surface S7, and the area of the eighth contact surface S8.

As illustrated in FIG. 3A, FIG. 3B, and FIG. 3C, the length of the bottom surface-side via wiring layer is larger than the length of the top surface-side via wiring layer when viewed in the direction of the axis AX. When viewed in the direction of the axis AX, the length of the bottom surface-side via wiring layer is the length of the central line along the extending direction of the bottom surface-side via wiring layer. Since the plurality of bottom surface-side via wiring layers is present, the length of the bottom surface-side via wiring layer is an average of all the measured lengths of the bottom surface-side via wiring layers. Similarly, when viewed in the direction of the axis AX, the length of the top surface-side via wiring layer is the length of the central line along the extending direction of the top surface-side via wiring layer. Since the plurality of top surface-side via wiring layers is present, the length of the top surface-side via wiring layer is an average of all the measured lengths of the top surface-side via wiring layers.

Specifically, the length of the bottom surface-side via wiring layer is an average of a first length L1 of the first via wiring layer 61, a second length L2 of the second via wiring layer 62, a fifth length L5 of the fifth via wiring layer 65, and a sixth length L6 of the sixth via wiring layer 66 (hereinafter referred to as a first average). The length of the top surface-side via wiring layer is an average of a third length L3 of the third via wiring layer 63 and a fourth length L4 of the fourth via wiring layer 64 (hereinafter referred to as a second average). The first average is larger than the second average.

As a method for measuring the length of each via wiring layer, for example, the inductor component 1 is ground along the XZ plane and the length of each via wiring layer is measured.

In the structure described above, the length of the bottom surface-side via wiring layer is larger than the length of the top surface-side via wiring layer when viewed in the direction of the axis AX. Therefore, the strength of the bottom surface-side via wiring layer can be improved, and damage to the bottom surface-side via wiring layer, such as a crack, can be prevented even if a great stress is applied to the bottom surface-side via wiring layer.

It is preferred that the lengths of all the bottom surface-side via wiring layers be larger than the lengths of all the top surface-side via wiring layers. Specifically, the first length L1, the second length L2, the fifth length L5, and the sixth length L6 are larger than the third length L3 and the fourth length L4.

It is preferred that the total of the lengths of the bottom surface-side via wiring layers be larger than the total of the lengths of the top surface-side via wiring layers. Specifically, the total of the first length L1, the second length L2, the fifth length L5, and the sixth length L6 is larger than the total of the third length L3 and the fourth length L4.

As illustrated in FIG. 2, FIG. 3A, FIG. 3B, and FIG. 3C, the distances of all the via wiring layers 61 to 66 in the helix direction of the coil 20 are equal to each other when viewed in the direction of the axis AX. When viewed in the direction of the axis AX, the distances of all the via wiring layers 61 to 66 in the helix direction of the coil 20 are each the length of the coil wiring layer positioned between the end portion of one via wiring layer and the end portion of the other via wiring layer for the via wiring layers adjacent in the helix direction of the coil 20. The length of the coil wiring layer is the length of a central line along the extending direction of the coil wiring layer.

Specifically, when viewed in the direction of the axis AX, the first via wiring layer 61 overlaps the fifth via wiring layer 65, and the second via wiring layer 62 overlaps the sixth via wiring layer 66. When viewed in the direction of the axis AX, the distance between the first via wiring layer 61 and the second via wiring layer 62 is equal to the distance between the fifth via wiring layer 65 and the sixth via wiring layer 66, and this distance is referred to as a first distance K1. The distance between the second via wiring layer 62 and the third via wiring layer 63 is equal to the distance between the sixth via wiring layer 66 and the third via wiring layer 63, and this distance is referred to as a second distance K2. The distance between the third via wiring layer 63 and the fourth via wiring layer 64 is referred to as a third distance K3. The distance between the fourth via wiring layer 64 and the first via wiring layer 61 is equal to the distance between the fourth via wiring layer 64 and the fifth via wiring layer 65, and this distance is referred to as a fourth distance K4. The first distance K1, the second distance K2, the third distance K3, and the fourth distance K4 are equal to each other. For the first via wiring layer 61 and the fifth via wiring layer 65 overlapping each other when viewed in the direction of the axis AX, the distance between the first via wiring layer 61 and the fifth via wiring layer 65 is not measured. For the second via wiring layer 62 and the sixth via wiring layer 66 overlapping each other when viewed in the direction of the axis AX, the distance between the second via wiring layer 62 and the sixth via wiring layer 66 is not measured.

As a method for measuring the distance of each via wiring layer, for example, the inductor component 1 is ground along the XZ plane and the distance of each via wiring layer is measured.

In the structure described above, current concentration points can be distributed in a current path of the coil 20, and a current loss can become unlikely to occur. That is, when viewed in the direction of the axis AX, portions between the via wiring layers adjacent in the helix direction of the coil where the current concentration is likely to occur can be positioned evenly in the helix direction of the coil 20, and therefore the current concentration points can be distributed.

As illustrated in FIG. 2, FIG. 3A, FIG. 3B, and FIG. 3C, the number of the bottom surface-side via wiring layers is different from the number of the top surface-side via wiring layers. It is preferred that the number of the bottom surface-side via wiring layers be larger than the number of the top surface-side via wiring layers. Specifically, the bottom surface-side via wiring layers are the first via wiring layer 61, the second via wiring layer 62, the fifth via wiring layer 65, and the sixth via wiring layer 66, and therefore the number of the bottom surface-side via wiring layers is four. The top surface-side via wiring layers are the third via wiring layer 63 and the fourth via wiring layer 64, and therefore the number of the top surface-side via wiring layers is two. In the structure described above, the degree of design freedom can be improved.

As illustrated in FIG. 2, FIG. 3A, FIG. 3B, and FIG. 3C, it is preferred that the length of the bottom surface-side via wiring layer is 110% or more and 195% or less (i.e., from 110% to 195%) of the length of the top surface-side via wiring layer when viewed in the direction of the axis AX. Specifically, the length of the bottom surface-side via wiring layer is the first average, and the length of the top surface-side via wiring layer is the second average. The first average is 110% or more and 195% or less (i.e., from 110% to 195%) of the second average.

In the structure described above, the strength of the bottom surface-side via wiring layer can be improved by increasing the length of the bottom surface-side via wiring layer. Since the length of the bottom surface-side via wiring layer is not excessively increased, the parallel connection region of the coil wiring layers adjacent in the direction of the axis AX is not excessively large.

It is preferred that the lengths of all the bottom surface-side via wiring layers be 110% or more and 195% or less (i.e., from 110% to 195%) of the lengths of all the top surface-side via wiring layers. Specifically, the first length L1, the second length L2, the fifth length L5, and the sixth length L6 are 110% or more and 195% or less (i.e., from 110% to 195%) of the third length L3 and the fourth length L4.

As illustrated in FIG. 2, FIG. 3A, FIG. 3B, and FIG. 3C, it is preferred that the ratio between the number of the bottom surface-side via wiring layers and the number of the top surface-side via wiring layers be 2:1, and the length of the bottom surface-side via wiring layer be 110% or more and 125% or less (i.e., from 110% to 125%) of the length of the top surface-side via wiring layer when viewed in the direction of the axis AX. Specifically, the number of the bottom surface-side via wiring layers is four and the number of the top surface-side via wiring layers is two. The first average is 110% or more and 125% or less (i.e., from 110% to 125%) of the second average.

In the structure described above, the strength of the bottom surface-side via wiring layer can be improved by increasing the length of the bottom surface-side via wiring layer. Since the length of the bottom surface-side via wiring layer is not excessively increased, the parallel connection region of the coil wiring layers adjacent in the direction of the axis AX is not excessively large.

It is preferred that the lengths of all the bottom surface-side via wiring layers be 110% or more and 125% or less (i.e., from 110% to 125%) of the lengths of all the top surface-side via wiring layers. Specifically, the first length L1, the second length L2, the fifth length L5, and the sixth length L6 are 110% or more and 125% or less (i.e., from 110% to 125%) of the third length L3 and the fourth length L4.

Next, a method for manufacturing the inductor component 1 is described.

As illustrated in FIG. 3A, FIG. 3B, and FIG. 3C, the inductor component 1 is manufactured by alternately laminating the first to seventh coil wiring layers 51 to 57 and the first to sixth via wiring layers 61 to 66 together with the insulating layers 11 from top to bottom in the figures. The coil wiring layers 51 to 57 are provided to the insulating layers 11, for example, by screen printing. The via wiring layers 61 to 66 are provided, for example, by screen printing in cavities that are provided to the insulating layers 11, for example, by a photolithography method or a laser method.

### Second Embodiment

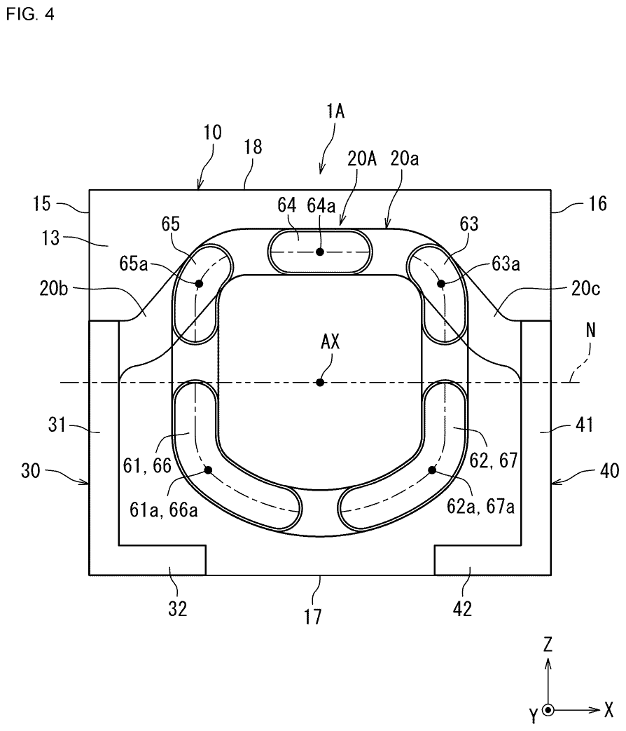

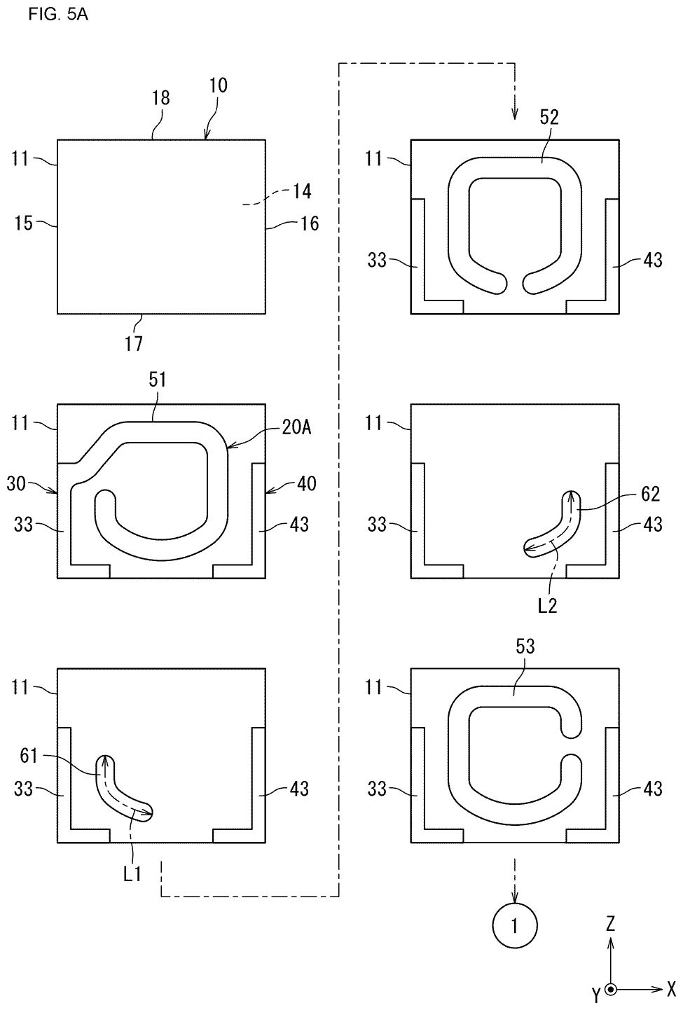

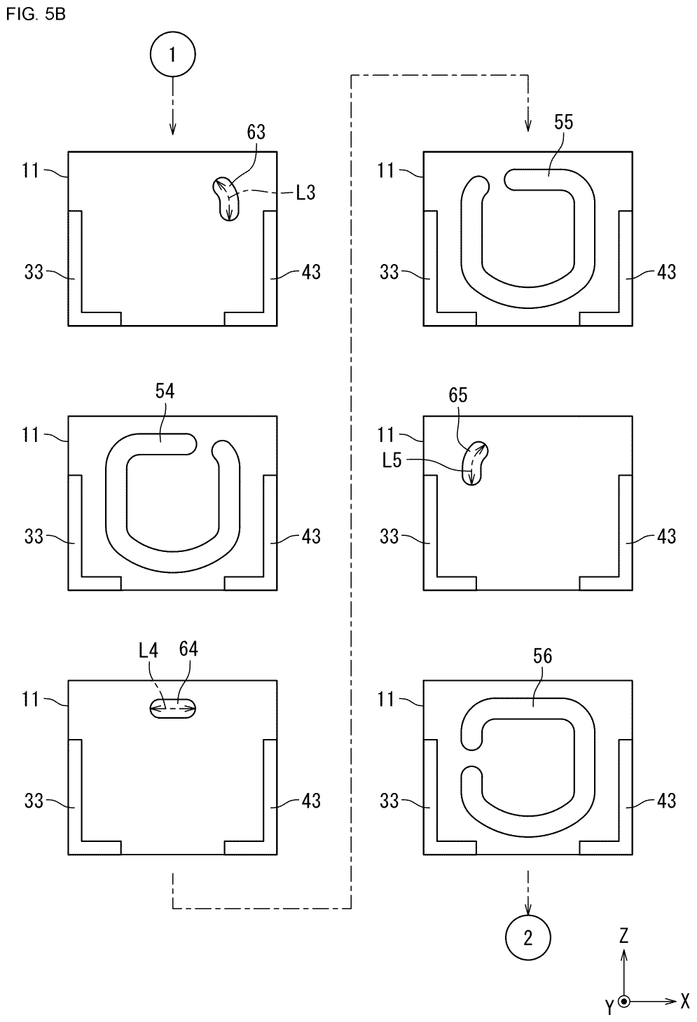

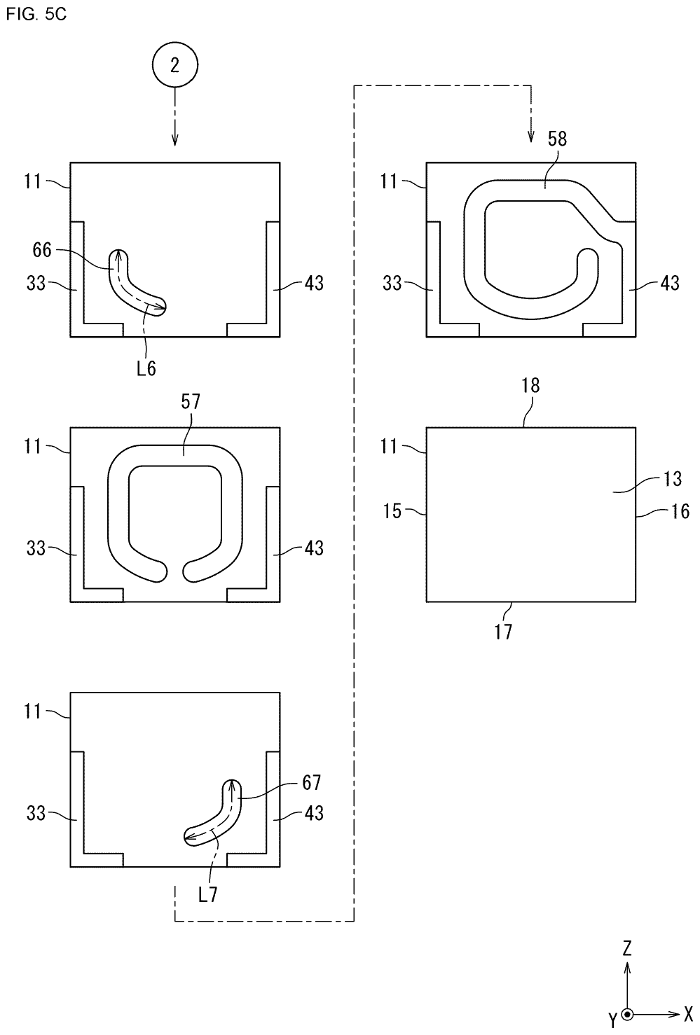

FIG. 4 is a see-through front view illustrating a second embodiment of the inductor component from the first lateral surface side of the inductor component. FIG. 5A, FIG. 5B, and FIG. 5C are exploded plan views of the inductor component. The second embodiment is different from the first embodiment in terms of the number and the lengths of the via wiring layers. This different structure is described below. The other structure is the same as that of the first embodiment, and the same reference symbols as in the first embodiment are assigned to omit description thereof.

As illustrated in FIG. 4, FIG. 5A, FIG. 5B, and FIG. 5C, in an inductor component 1A of the second embodiment, a coil 20A includes eight coil wiring layers 51 to 58 and seven via wiring layers 61 to 67. Specifically, the first coil wiring layer 51, the first via wiring layer 61, the second coil wiring layer 52, the second via wiring layer 62, the third coil wiring layer 53, the third via wiring layer 63, the fourth coil wiring layer 54, the fourth via wiring layer 64, the fifth coil wiring layer 55, the fifth via wiring layer 65, the sixth coil wiring layer 56, the sixth via wiring layer 66, the seventh coil wiring layer 57, the seventh via wiring layer 67, and the eighth coil wiring layer 58 are sequentially laminated along the Y direction.

The bottom surface-side via wiring layers are the first via wiring layer 61, the second via wiring layer 62, the sixth via wiring layer 66, and the seventh via wiring layer 67. Specifically, the central point 61a of the first via wiring layer 61 is present on the bottom surface 17 side with respect to the central line N. The central point 62a of the second via wiring layer 62 is present on the bottom surface 17 side with respect to the central line N. The central point 66a of the sixth via wiring layer 66 is present on the bottom surface 17 side with respect to the central line N. A central point 67a of the seventh via wiring layer 67 is present on the bottom surface 17 side with respect to the central line N.

The top surface-side via wiring layers are the third via wiring layer 63, the fourth via wiring layer 64, and the fifth via wiring layer 65. Specifically, the central point 63a of the third via wiring layer 63 is present on the top surface 18 side with respect to the central line N. The central point 64a of the fourth via wiring layer 64 is present on the top surface 18 side with respect to the central line N. The central point 65a of the fifth via wiring layer 65 is present on the top surface 18 side with respect to the central line N.

Similarly to the first embodiment, the contact area between the bottom surface-side via wiring layer and the coil wiring layer is larger than the contact area between the top surface-side via wiring layer and the coil wiring layer. Specifically, the contact area between the bottom surface-side via wiring layer and the coil wiring layer is an average of the areas of the contact surfaces between the first, second, sixth, and seventh via wiring layers 61, 62, 66, and 67 and the first, second, third, sixth, seventh, and eighth coil wiring layers 51, 52, 53, 56, 57, and 58. The contact area between the top surface-side via wiring layer and the coil wiring layer is an average of the areas of the contact surfaces between the third, fourth, and fifth via wiring layers 63, 64, and 65 and the third, fourth, fifth, and sixth coil wiring layers 53, 54, 55, and 56. Therefore, when the inductor component 1A is mounted on the mounting board so that the bottom surface 17 side of the element body 10 faces the mounting board, the connection strength between the bottom surface-side via wiring layer closer to the mounting board and the coil wiring layer can further be improved.

Similarly to the first embodiment, the length of the bottom surface-side via wiring layer is larger than the length of the top surface-side via wiring layer when viewed in the direction of the axis AX. Specifically, the length of the bottom surface-side via wiring layer is an average of the first length L1 of the first via wiring layer 61, the second length L2 of the second via wiring layer 62, the sixth length L6 of the sixth via wiring layer 66, and a seventh length L7 of the seventh via wiring layer 67 (hereinafter referred to as the first average). The length of the top surface-side via wiring layer is an average of the third length L3 of the third via wiring layer 63, the fourth length L4 of the fourth via wiring layer 64, and the fifth length L5 of the fifth via wiring layer 65 (hereinafter referred to as the second average). The first average is larger than the second average. Therefore, the strength of the bottom surface-side via wiring layer can be improved, and damage to the bottom surface-side via wiring layer, such as a crack, can be prevented even if a great stress is applied to the bottom surface-side via wiring layer.

Similarly to the first embodiment, the distances of all the via wiring layers 61 to 67 in the helix direction of the coil 20A are equal to each other when viewed in the direction of the axis AX. Specifically, when viewed in the direction of the axis AX, the first via wiring layer 61 overlaps the sixth via wiring layer 66, and the second via wiring layer 62 overlaps the seventh via wiring layer 67. When viewed in the direction of the axis AX, the distance between the first via wiring layer 61 and the second via wiring layer 62, the distance between the sixth via wiring layer 66 and the seventh via wiring layer 67, the distance between the second via wiring layer 62 and the third via wiring layer 63, the distance between the seventh via wiring layer 67 and the third via wiring layer 63, the distance between the third via wiring layer 63 and the fourth via wiring layer 64, the distance between the fourth via wiring layer 64 and the fifth via wiring layer 65, the distance between the fifth via wiring layer 65 and the first via wiring layer 61, and the distance between the fifth via wiring layer 65 and the sixth via wiring layer 66 are equal to each other. Therefore, current concentration points can be distributed in a current path of the coil 20A, and a current loss can become unlikely to occur.

As illustrated in FIG. 4, FIG. 5A, FIG. 5B, and FIG. 5C, the ratio between the number of the bottom surface-side via wiring layers and the number of the top surface-side via wiring layers is 4:3, and the length of the bottom surface-side via wiring layer is 180% or more and 195% or less (i.e., from 180% to 195%) of the length of the top surface-side via wiring layer when viewed in the direction of the axis AX. Specifically, the number of the bottom surface-side via wiring layers is four and the number of the top surface-side via wiring layers is three. The first average is 180% or more and 195% or less (i.e., from 180% to 195%) of the second average.

In the structure described above, the strength of the bottom surface-side via wiring layer can be improved by increasing the length of the bottom surface-side via wiring layer. Since the length of the bottom surface-side via wiring layer is not excessively increased, the parallel connection region of the coil wiring layers adjacent in the direction of the axis AX is not excessively large.

It is preferred that the lengths of all the bottom surface-side via wiring layers be 180% or more and 195% or less (i.e., from 180% to 195%) of the lengths of all the top surface-side via wiring layers. Specifically, the first length L1, the second length L2, the sixth length L6, and the seventh length L7 are 180% or more and 195% or less (i.e., from 180% to 195%) of the third length L3, the fourth length L4, and the fifth length L5.

### Third Embodiment

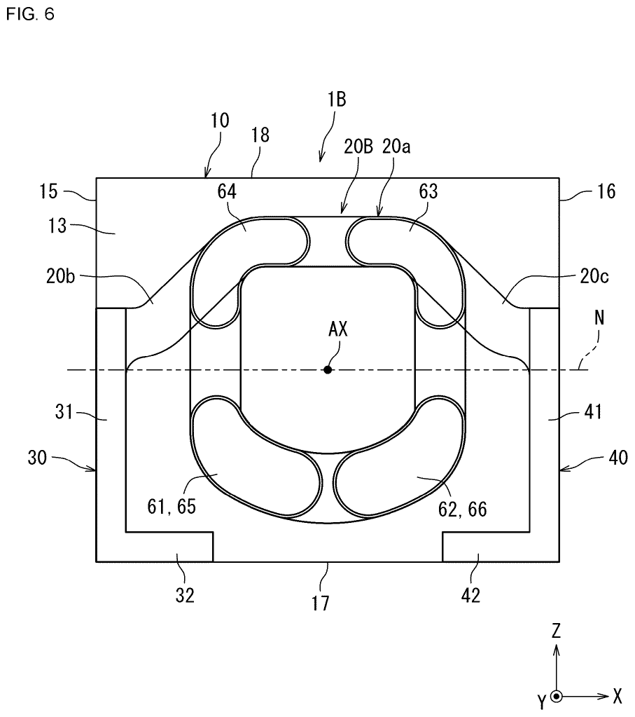

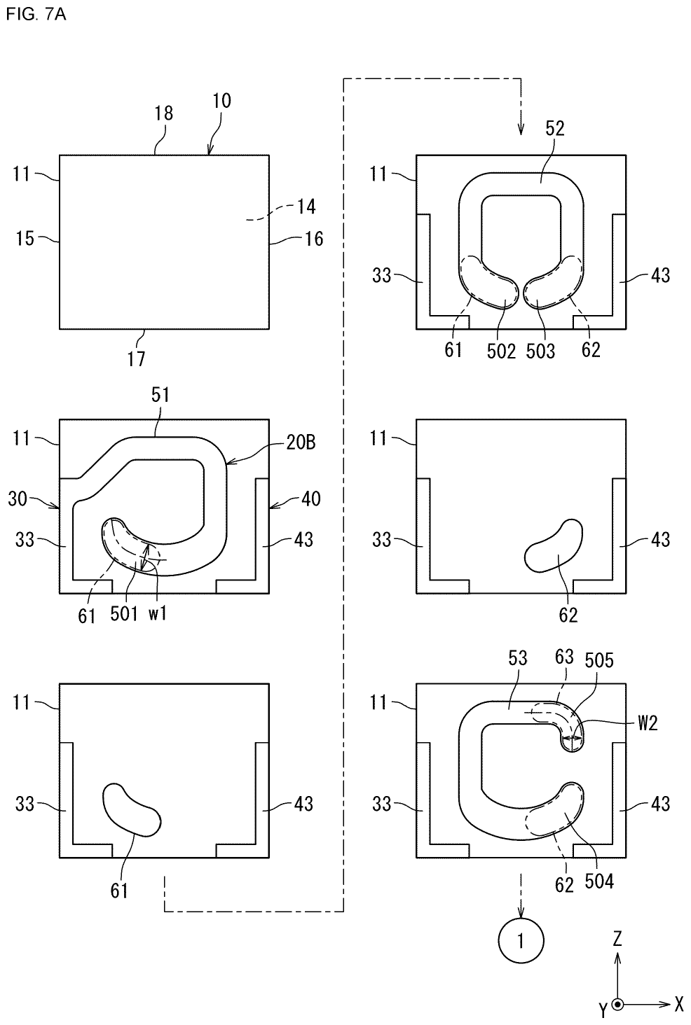

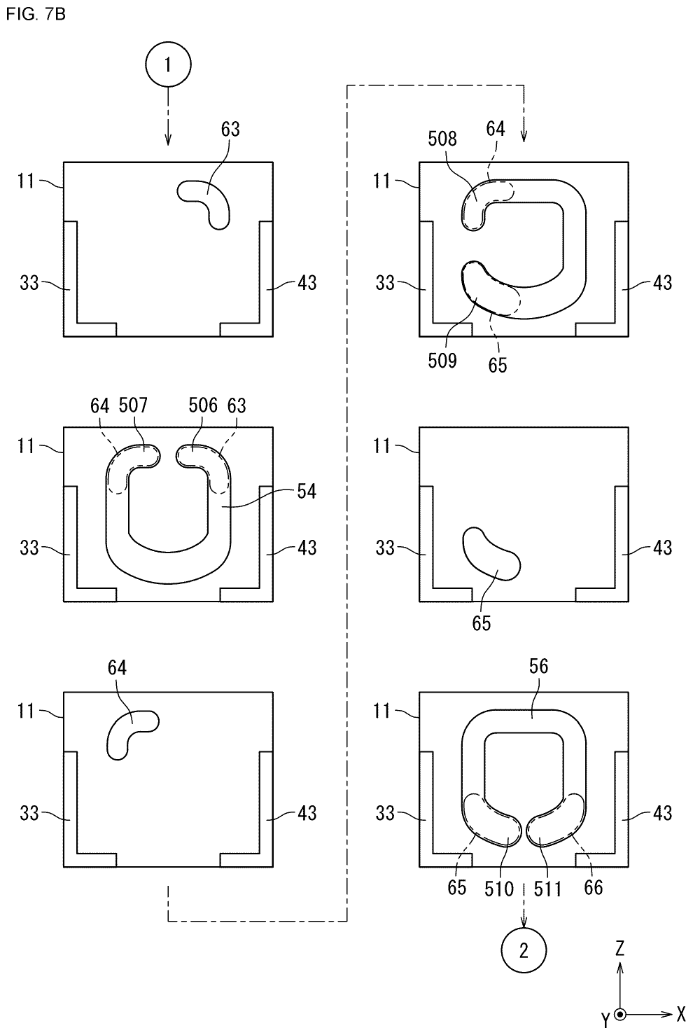

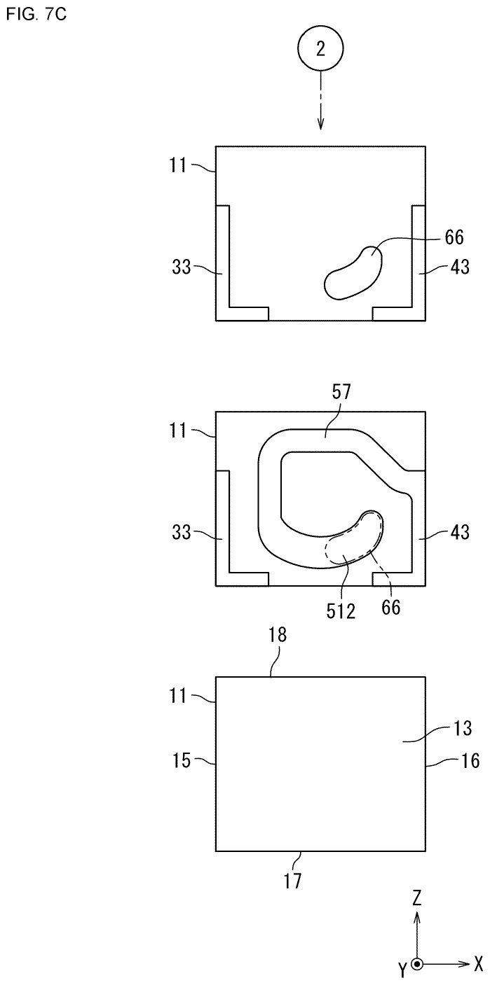

FIG. 6 is a see-through front view illustrating a third embodiment of the inductor component from the first lateral surface side of the inductor component. FIG. 7A, FIG. 7B, and FIG. 7C are exploded plan views of the inductor component. The third embodiment is different from the first embodiment in terms of the widths of the coil wiring layers. This different structure is described below. The other structure is the same as that of the first embodiment, and the same reference symbols as in the first embodiment are assigned to omit description thereof.

As illustrated in FIG. 6, FIG. 7A, FIG. 7B, and FIG. 7C, in a coil 20B of an inductor component 1B of the third embodiment, the coil wiring layer in contact with the bottom surface-side via wiring layer includes a bottom surface-side contact portion in contact with the bottom surface-side via wiring layer when viewed in the direction of the axis AX. The coil wiring layer in contact with the top surface-side via wiring layer includes a top surface-side contact portion in contact with the top surface-side via wiring layer.

Specifically, the bottom surface-side via wiring layers are the first via wiring layer 61, the second via wiring layer 62, the fifth via wiring layer 65, and the sixth via wiring layer 66. The top surface-side via wiring layers are the third via wiring layer 63 and the fourth via wiring layer 64.

The first coil wiring layer 51 includes a first contact portion 501 in contact with the first via wiring layer 61. The second coil wiring layer 52 includes a second contact portion 502 in contact with the first via wiring layer 61, and a third contact portion 503 in contact with the second via wiring layer 62. The third coil wiring layer 53 includes a fourth contact portion 504 in contact with the second via wiring layer 62, and a fifth contact portion 505 in contact with the third via wiring layer 63. The fourth coil wiring layer 54 includes a sixth contact portion 506 in contact with the third via wiring layer 63, and a seventh contact portion 507 in contact with the fourth via wiring layer 64. The fifth coil wiring layer 55 includes an eighth contact portion 508 in contact with the fourth via wiring layer 64, and a ninth contact portion 509 in contact with the fifth via wiring layer 65. The sixth coil wiring layer 56 includes a tenth contact portion 510 in contact with the fifth via wiring layer 65, and an eleventh contact portion 511 in contact with the sixth via wiring layer 66. The seventh coil wiring layer 57 includes a twelfth contact portion 512 in contact with the sixth via wiring layer 66.

The bottom surface-side contact portions are the first contact portion 501, the second contact portion 502, the third contact portion 503, the fourth contact portion 504, the ninth contact portion 509, the tenth contact portion 510, the eleventh contact portion 511, and the twelfth contact portion 512. The top surface-side contact portions are the fifth contact portion 505, the sixth contact portion 506, the seventh contact portion 507, and the eighth contact portion 508.

The width of the bottom surface-side contact portion is larger than the width of the top surface-side contact portion. When viewed in the direction of the axis AX, the width of the bottom surface-side contact portion is the maximum width of the bottom surface-side contact portion (for example, a width W1 of the first contact portion 501) in a direction orthogonal to the central line along the extending direction of the coil wiring layer. Since the plurality of bottom surface-side contact portions is present including the first contact portion 501, the second contact portion 502, the third contact portion 503, the fourth contact portion 504, the ninth contact portion 509, the tenth contact portion 510, the eleventh contact portion 511, and the twelfth contact portion 512, the width of the bottom surface-side contact portion is an average of all the measured widths of the bottom surface-side contact portions. That is, the width of the bottom surface-side contact portion is an average of the width of the first contact portion 501, the width of the second contact portion 502, the width of the third contact portion 503, the width of the fourth contact portion 504, the width of the ninth contact portion 509, the width of the tenth contact portion 510, the width of the eleventh contact portion 511, and the width of the twelfth contact portion 512.

Similarly, when viewed in the direction of the axis AX, the width of the top surface-side contact portion is the maximum width of the top surface-side contact portion (for example, a width W2 of the fifth contact portion 505) in a direction orthogonal to the central line along the extending direction of the coil wiring layer. Since the plurality of top surface-side contact portions is present including the fifth contact portion 505, the sixth contact portion 506, the seventh contact portion 507, and the eighth contact portion 508, the width of the top surface-side contact portion is an average of all the measured widths of the top surface-side contact portions. That is, the width of the top surface-side contact portion is an average of the width of the fifth contact portion 505, the width of the sixth contact portion 506, the width of the seventh contact portion 507, and the width of the eighth contact portion 508.

As a method for measuring the width of each contact portion, for example, the inductor component 1B is ground along the XZ plane and the width of each contact portion is measured.

In the structure described above, the width of the bottom surface-side contact portion is larger than the width of the top surface-side contact portion. Therefore, the strength of the bottom surface-side contact portion can be improved, and damage to the bottom surface-side contact portion, such as a crack, can be prevented even if a great stress is applied to the bottom surface-side contact portion.

It is preferred that the widths of all the bottom surface-side contact portions be larger than the widths of all the top surface-side contact portions. Specifically, the width of the first contact portion 501, the width of the second contact portion 502, the width of the third contact portion 503, the width of the fourth contact portion 504, the width of the ninth contact portion 509, the width of the tenth contact portion 510, the width of the eleventh contact portion 511, and the width of the twelfth contact portion 512 are larger than the width of the fifth contact portion 505, the width of the sixth contact portion 506, the width of the seventh contact portion 507, and the width of the eighth contact portion 508.

The present disclosure is not limited to the embodiments described above, and the design may be changed without departing from the gist of the present disclosure. For example, the features of the first to third embodiments may be combined variously. The number of the coil wiring layers may be increased or reduced. The number of the via wiring layers may be increased or reduced. The number of the bottom surface-side via wiring layers may be smaller than the number of the top surface-side via wiring layers.

The present disclosure includes the following aspects.

<1> An inductor component including an element body; a coil provided in the element body and helically wound along an axis; and a first outer electrode and a second outer electrode provided to the element body and electrically connected to the coil. The element body includes a first end surface and a second end surface facing each other, a first lateral surface and a second lateral surface facing each other, a bottom surface connected between the first end surface and the second end surface and between the first lateral surface and the second lateral surface, and a top surface facing the bottom surface. The first outer electrode and the second outer electrode are provided to at least the bottom surface. The axis is parallel to the bottom surface and intersects the first lateral surface and the second lateral surface. The coil includes a plurality of coil wiring layers laminated along the axis, and a plurality of via wiring layers each connecting the coil wiring layers adjacent in a direction of the axis. The plurality of via wiring layers extends along a helix direction of the coil when viewed in the direction of the axis, and the plurality of via wiring layers includes a bottom surface-side via wiring layer positioned on the bottom surface side with respect to a central line between the top surface and the bottom surface of the element body, and a top surface-side via wiring layer positioned on the top surface side with respect to the central line. A contact area between the bottom surface-side via wiring layer and the coil wiring layer is larger than a contact area between the top surface-side via wiring layer and the coil wiring layer.

<2> The inductor component according to <1>, in which a length of the bottom surface-side via wiring layer is larger than a length of the top surface-side via wiring layer when viewed in the direction of the axis.

<3> The inductor component according to <1> or <2>, in which, when viewed in the direction of the axis, the coil wiring layer in contact with the bottom surface-side via wiring layer includes a bottom surface-side contact portion in contact with the bottom surface-side via wiring layer, and the coil wiring layer in contact with the top surface-side via wiring layer includes a top surface-side contact portion in contact with the top surface-side via wiring layer. Also, a width of the bottom surface-side contact portion is larger than a width of the top surface-side contact portion.

<4> The inductor component according to any one of <1> to <3>, in which distances of all the via wiring layers in the helix direction of the coil are equal to each other when viewed in the direction of the axis.

<5> The inductor component according to any one of <1> to <4>, in which the number of the bottom surface-side via wiring layers is different from the number of the top surface-side via wiring layers.

<6> The inductor component according to any one of <1> to <5>, in which the number of the bottom surface-side via wiring layers is larger than the number of the top surface-side via wiring layers.

<7> The inductor component according to any one of <1> to <6>, in which a length of the bottom surface-side via wiring layer is 110% or more and 195% or less (i.e., from 110% to 195%) of a length of the top surface-side via wiring layer when viewed in the direction of the axis.

<8> The inductor component according to any one of <1> to <6>, in which a ratio between the number of the bottom surface-side via wiring layers and the number of the top surface-side via wiring layers is 2:1. Also, a length of the bottom surface-side via wiring layer is 110% or more and 125% or less (i.e., from 110% to 125%) of a length of the top surface-side via wiring layer when viewed in the direction of the axis.

<9> The inductor component according to any one of <1> to <6>, in which a ratio between the number of the bottom surface-side via wiring layers and the number of the top surface-side via wiring layers is 4:3. Also, a length of the bottom surface-side via wiring layer is 180% or more and 195% or less (i.e., from 180% to 195%) of a length of the top surface-side via wiring layer when viewed in the direction of the axis.

What is claimed is:

1. An inductor component comprising:
an element body comprising a first end surface and a second end surface facing each other, a first lateral surface and a second lateral surface facing each other, a bottom surface connected between the first end surface and the second end surface and between the first lateral surface and the second lateral surface, and a top surface facing the bottom surface;
a coil in the element body and helically wound along an axis that is parallel to the bottom surface and intersects the first lateral surface and the second lateral surface,
the coil comprising a plurality of coil wiring layers laminated along the axis, and a plurality of via wiring layers each connecting adjacent coil wiring layers in a direction of the axis,
the plurality of via wiring layers extending along a helix direction of the coil when viewed in the direction of the axis; and
a first outer electrode and a second outer electrode on at least the bottom surface of the element body and electrically connected to the coil,
wherein
the plurality of via wiring layers includes a bottom surface-side via wiring layer positioned on the bottom surface side with respect to a central line between the top surface and the bottom surface of the element body, and a top surface-side via wiring layer positioned on the top surface side with respect to the central line, and
a contact area in which the bottom surface-side via wiring layer and the coil wiring layer contact is larger than a contact area in which the top surface-side via wiring layer and the coil wiring layer contact.

2. The inductor component according to claim 1, wherein
a length of the bottom surface-side via wiring layer is longer than a length of the top surface-side via wiring layer when viewed in the direction of the axis.

3. The inductor component according to claim 1, wherein
when viewed in the direction of the axis,
the coil wiring layer which is in contact with the bottom surface-side via wiring layer includes a bottom surface-side contact portion in contact with the bottom surface-side via wiring layer, and
the coil wiring layer which is in contact with the top surface-side via wiring layer includes a top surface-side contact portion in contact with the top surface-side via wiring layer, and
a width of the bottom surface-side contact portion is larger than a width of the top surface-side contact portion.

4. The inductor component according to claim 1, wherein
distances between each of the via wiring layers in the helix direction of the coil are equal when viewed in the direction of the axis.

5. The inductor component according to claim 1, wherein
a number of the bottom surface-side via wiring layers is different from a number of the top surface-side via wiring layers.

6. The inductor component according to claim 5, wherein
the number of the bottom surface-side via wiring layers is larger than the number of the top surface-side via wiring layers.

7. The inductor component according to claim 1, wherein
a length of the bottom surface-side via wiring layer is from 110% to 195% of a length of the top surface-side via wiring layer when viewed in the direction of the axis.

8. The inductor component according to claim 1, wherein
a ratio between the number of the bottom surface-side via wiring layers and the number of the top surface-side via wiring layers is 2:1, and
a length of the bottom surface-side via wiring layer is from 110% to 125% of a length of the top surface-side via wiring layer when viewed in the direction of the axis.

9. The inductor component according to claim 1, wherein
a ratio between a number of the bottom surface-side via wiring layers and a number of the top surface-side via wiring layers is 4:3, and
a length of the bottom surface-side via wiring layer is from 180% to 195% of a length of the top surface-side via wiring layer when viewed in the direction of the axis.

10. The inductor component according to claim 2, wherein
when viewed in the direction of the axis,
the coil wiring layer which is in contact with the bottom surface-side via wiring layer includes a bottom surface-side contact portion in contact with the bottom surface-side via wiring layer, and
the coil wiring layer which is in contact with the top surface-side via wiring layer includes a top surface-side contact portion in contact with the top surface-side via wiring layer, and
a width of the bottom surface-side contact portion is larger than a width of the top surface-side contact portion.

11. The inductor component according to claim 2, wherein
distances between each of the via wiring layers in the helix direction of the coil are equal when viewed in the direction of the axis.

12. The inductor component according to claim 2, wherein
a number of the bottom surface-side via wiring layers is different from a number of the top surface-side via wiring layers.

13. The inductor component according to claim 12, wherein
the number of the bottom surface-side via wiring layers is larger than the number of the top surface-side via wiring layers.

14. The inductor component according to claim 2, wherein
a length of the bottom surface-side via wiring layer is from 110% to 195% of a length of the top surface-side via wiring layer when viewed in the direction of the axis.

15. The inductor component according to claim 2, wherein
a ratio between the number of the bottom surface-side via wiring layers and the number of the top surface-side via wiring layers is 2:1, and
a length of the bottom surface-side via wiring layer is from 110% to 125% of a length of the top surface-side via wiring layer when viewed in the direction of the axis.

16. The inductor component according to claim 2, wherein
a ratio between a number of the bottom surface-side via wiring layers and a number of the top surface-side via wiring layers is 4:3, and
a length of the bottom surface-side via wiring layer is from 180% to 195% of a length of the top surface-side via wiring layer when viewed in the direction of the axis.
